(19) United States
(12) Patent Application Publication
(10) Pub. No.: US 2026/0081389 A1
(43) Pub. Date: Mar. 19, 2026

(54) ELECTRICAL CONNECTOR MOUNTING STRUCTURE

(71) Applicant: Aisin Corporation, Kariya Aichi (JP)

(72) Inventors: Aaron Welter, Toledo, OH (US); Ryan Heins, Wixom, MI (US)

(21) Appl. No.: 18/888,824

(22) Filed: Sep. 18, 2024

(51) Int. Cl. H01R 13/73; B60R 16/02; B62D 33/027

(52) U.S. Cl. CPC H01R 13/73; B60R 16/0207; B62D 33/0273; H01R 2201/26

(57) ABSTRACT

An electrical connector mounting structure enables attachment of a wiring harness to a panel of a vehicle. The mounting structure includes a base portion having a first-side and a second-side opposite the first side. A first-side wall is connected to the base portion and positioned on the base portion first side. Another first-side wall is connected to the base portion and positioned on the base portion first side opposite the first-side wall. A second-side wall extends from the base portion second side. Another second-side wall extends from the base portion second side opposite the second-side wall. The mounting structure enables a connector terminating the wires of a wire harness to be mounted directly to a panel of a vehicle without additional attachment hardware using mating features already present on the connector assembly, and also enables the length of an attached wire harness to be minimized.

### TECHNICAL FIELD

The subject matter described herein relates to an electrical connector mounting structure and, more particularly, to a connector mounting structure configured to enable mounting of an electrical connector terminating a wire harness to a portion of a vehicle so as to enable a complementary electrical connector to be mated with the mounted connector.

### BACKGROUND

In the assembly of motor vehicles, it is often necessary to use wire harnesses used to interconnect various electrical components of the vehicle. Electrical connectors may be used for centralized termination of multiple wires of a wire harness. A challenge with the use of wire harnesses is specifying precise lengths of the harness wires needed to connect the electrical components. The wires and associated connectors may need to be secured to available portions of the vehicle along the length of each harness, to prevent damage to the harness components during handling and vehicle assembly, and to prevent rattling and vibration of loose harness components during operation of the vehicle. The need to secure the wire harness to the vehicle may increase vehicle assembly labor and material costs. In view of the above, it is generally beneficial to accurately specify the lengths of wire harnesses installed in the vehicle.

### SUMMARY

In one aspect of the embodiments described herein, an electrical connector mounting structure includes a base portion having a first-side and a second-side opposite the first side. A first-side wall is connected to the base portion and positioned on the base portion first side. Another first-side wall is connected to the base portion and positioned on the base portion first side opposite the first-side wall. A second-side wall extends from the base portion second side, and another second-side wall extends from the base portion second side opposite the second-side wall.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. Furthermore, elements may not be drawn to scale. Also, similar elements in the same or different views may be labeled with similar reference characters.

FIG. 1 is a schematic perspective view of a vehicle door assembly including a touch sensor assembly incorporating an electrical connector mounting structure in accordance with an embodiment described herein.

FIG. 2A is a schematic perspective view of a touch sensor assembly structured for incorporation into a vehicle door assembly in accordance with an embodiment described herein, showing an exterior side of a body of the sensor assembly and a sensor strip of the touch sensor assembly mounted along the body.

FIG. 2B is a schematic perspective view of the sensor assembly body shown in FIG. 2A, showing an interior side of the sensor assembly body opposite the exterior side, with a wire harness connector assembly mounted along the interior side.

FIG. 3 is a schematic perspective view of an exemplary electrical connector mounting structure formed integrally with the sensor assembly body of FIGS. 2A and 2B.

FIG. 4 is a schematic perspective view of the connector mounting structure of FIG. 3 and an exemplary wire harness connector assembly including a connector structured for mating engagement with the connector mounting structure.

FIG. 5 is the schematic perspective view of FIG. 4 showing the connector mated with the connector mounting structure.

FIG. 6 is a schematic plan view of the connector mated to the connector mounting structure as shown in FIG. 5.

FIG. 6A is a schematic side cross-sectional view of a portion of the connector and connector mounting structure in the mated condition of FIGS. 4-6, showing a latch arm engaged of the connector engaged with a latch-receiving cavity.

### DETAILED DESCRIPTION

Embodiments described herein relate to an electrical connector mounting structure enabling attachment of a wiring harness to a touch sensor of a vehicle. The electrical connector mounting structure may include a base portion having a first-side and a second-side opposite the first side. A first-side wall is connected to the base portion and positioned on the base portion first side. Another first-side wall is connected to the base portion and positioned on the base portion first side opposite the first-side wall. A second-side wall extends from the base portion second side, and another second-side wall extends from the base portion second side opposite the second-side wall. In some arrangements, the connector mounting structure may be formed integrally with a body of a touch sensor to which an electrical connector of the wire harness is to be attached. The electrical connector mounting structure embodiments described herein enable a wire harness connector assembly terminating the wires of a wire harness to be mounted directly and securely to a touch sensor of a vehicle without additional attachment hardware, using mating features already present on the connector assembly. The mounting structure embodiments described herein also enable the length of an attached wire harness to be minimized.

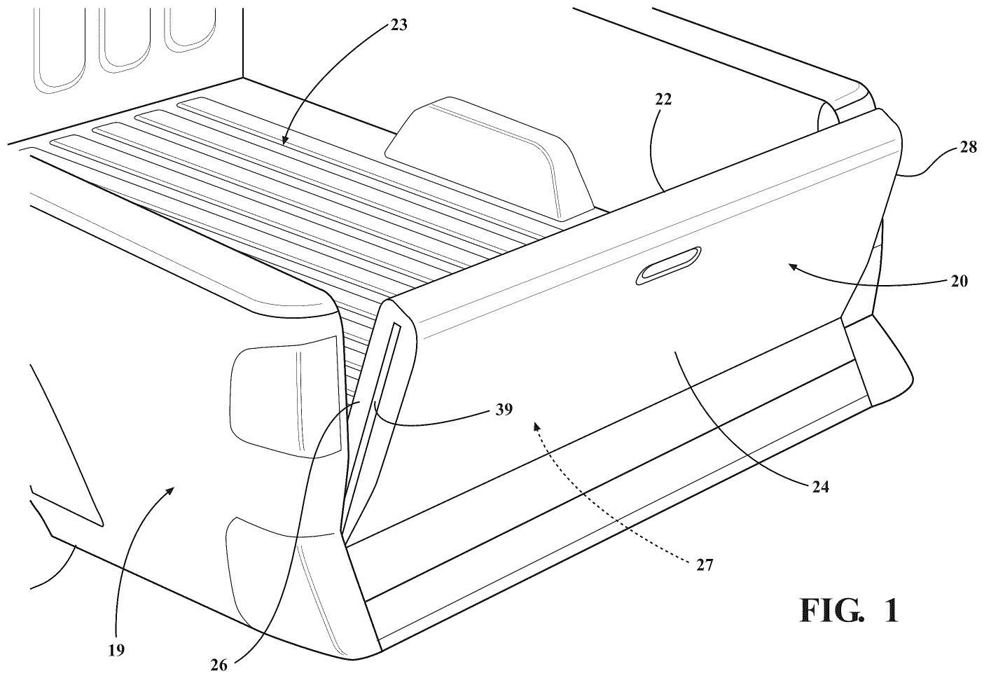

FIG. 1 is a schematic perspective view of a vehicle door assembly 20 including a touch sensor incorporating an electrical connector mounting structure in accordance with an embodiment described herein. In one or more arrangements, and as described herein, the vehicle 19 may be in form of a pickup truck, and the vehicle door assembly 20 may form a tailgate of the pickup truck. However, embodiments of the connector mounting structure may be incorporated into other types of door assemblies (e.g., a liftgate, sliding door, etc.) used in other types of vehicles. In one or more arrangements, the door assembly 20 may include an inner door panel 22, an outer door panel 24, and a pair opposed vehicle door touch sensor assemblies 26, 28 extending between the inner door panel 22 and the outer door panel 24. As known in the pertinent art, the touch sensor (or “pinch sensor”) assemblies 26, 28 may be configured to contact and detect an object (such as a human hand, finger, or other obstacle) positioned between the door assembly 20 and the vehicle body during closing of the door assembly. Closing of the door assembly may be halted responsive to detection of the object by the sensor.

In one or more arrangements, the inner door panel 22 may be structured to face in a direction toward a cargo bed 23 of the vehicle 19 when the door assembly 20 is installed on the vehicle 19 in its end-use configuration. The outer door panel 24 may be structured to extend along an exterior surface of the vehicle door assembly 20 and to face in a direction away from the cargo bed 23 when the vehicle door assembly 20 is installed on the vehicle 19 in its end-use configuration. As shown in FIG. 1, each of vehicle door touch sensor assemblies 26, 28 may be attached to the inner door panel 22 and the outer door panel 24 so as to extend between the inner door panel 22 and the outer door panel 24 along opposite side edges of the vehicle door assembly 20. As known in the pertinent field, the various door panels 22, 24 and the touch sensor assemblies 26, 28 may combine to form an enclosure 27 inside the assembled vehicle door assembly 20. The enclosure 27 may contain various elements and mechanisms (not shown) enabling and/or facilitating operations of the vehicle door assembly 20, such as raising and lowering the vehicle door assembly, locking and unlocking the door assembly, etc.

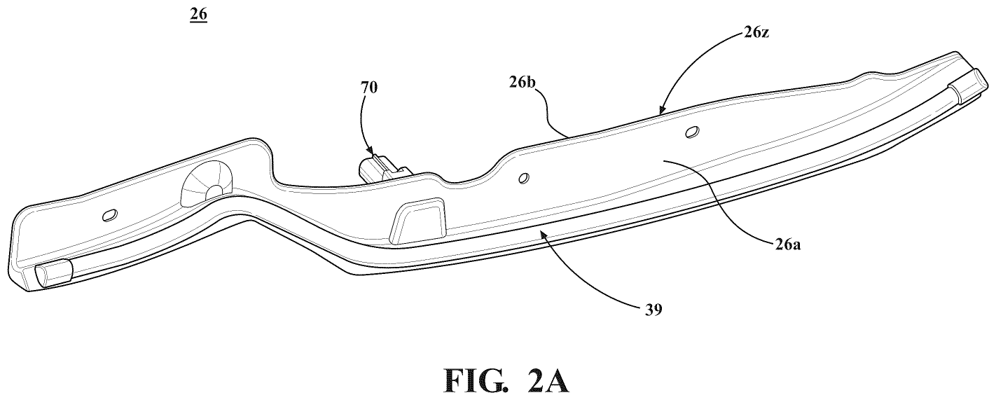

FIG. 2A is a schematic perspective view of an exemplary vehicle door touch sensor assembly 26 including a body 26z having an exterior side 26a, an interior side 26b opposite the exterior side 26a, and a touch sensor strip 39 mounted along the body exterior side 26a. FIG. 2B is a schematic perspective view of the touch sensor shown in FIG. 2A, showing the interior side 26b of the touch sensor assembly body opposite the exterior side 26a, with a wire harness connector assembly 70 (described in greater detail below) mounted along the interior side 26b. In some arrangements, the touch sensor 28 may be structured the same as the touch sensor assembly 26 according to the following description. When a touch sensor is incorporated into the door assembly 20, the interior side 26b of the touch sensor assembly body 26z may reside inside the door enclosure 27 between the inner and outer door panels 22, 24, and the exterior side 26a of the touch sensor assembly body 26z may be exposed to the exterior environment of the door assembly 20 when the door assembly is opened, to enable the touch sensor strip 39 to be mounted along an outwardly-facing portion of the touch sensor assembly body 26z.

Referring to FIGS. 2A and 2B, each touch sensor body may provide a base for mounting of an associated touch sensor strip 39 along an associated edge of the vehicle door assembly 20, to detect part of user's hand or other foreign object placed between the touch sensor strip 39 and the vehicle body during closing of the vehicle door assembly 20.

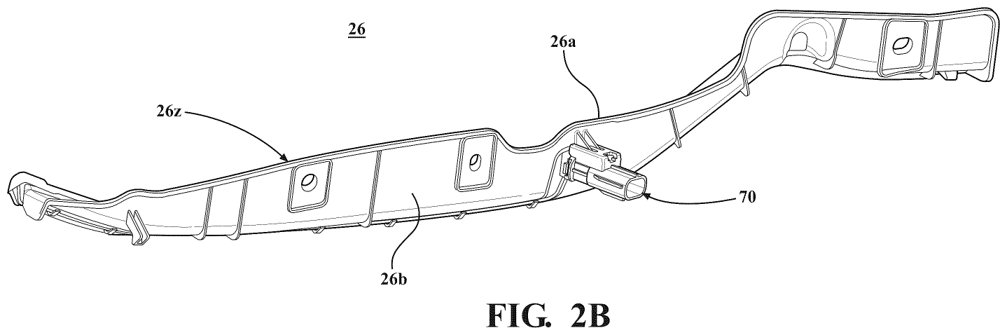

FIG. 3 is a schematic perspective view of an exemplary electrical connector mounting structure (generally designated 30) formed integrally with the touch sensor assembly body 26z. In one or more arrangements, the connector mounting structure 30 may be incorporated into the touch sensor assembly body 26z to enable attachment of the electrical connector assembly 70 to the touch sensor assembly body.

In one or more arrangements, the connector mounting structure 30 may include a base portion 31 having a first face 31a and a second face 31b residing opposite the first face 31a. The base portion 31 may have a thickness dimension t1 extending between first and second faces 31a, 31b. The first face 31a may define a first plane P1 including (but not limited to) the first face, and the second face 31b may define a second plane P2 including (but not limited to) the second face and extending opposite the first plane P1. In some arrangements, the first and second faces 31a, 31b are structured to be flat and thickness dimension t1 is structured to be uniform or substantially uniform along an extent of the base portion 31, within associated dimensional tolerances of the base portion 31. In such arrangements, the first and second faces 31a, 31b (and associated first and second planes P1 and P2) are structured to be parallel or substantially parallel with each other.

Referring to FIG. 3, in one or more arrangements, the connector mounting structure 30 may include a first-side wall 32 connected to the base portion 31 and positioned on a first side S1 of the base portion 31. As used herein, the term “connected” refers to both direct physical contact between elements and indirect connections between the elements (i.e., through one or more intermediate parts interposed between the elements). For purposes described herein, a “first-side wall” is a wall positioned along the first side S1 of the base portion 31. for purposes described herein, a feature of the connector mounting structure is positioned “along” or “on” the first side S1 of the base portion 31 when it extends from the base portion first face 31a (i.e., when the feature is in direct physical contact with the first face 31a) and/or when the feature is spaced apart from the first plane P1 in a direction D1 extending from the first plane P1. The connector mounting structure may also include another first-side wall 33 connected to the base portion 31 and positioned on the base portion first side S1 opposite the first-side wall 32.

Referring to FIG. 3, in one or more arrangements, the connector mounting structure 30 may also include a second-side wall 34 extending from the base portion 31 and positioned on the base portion second side S2. For purposes described herein, a “second-side wall” is a wall positioned along a second side S2 of the base portion 31. for purposes described herein, a feature of the connector mounting structure is positioned “along” or “on” the second side S2 of the base portion 31 when it extends from the base portion second face 31b (i.e., when the feature is in direct physical contact with the second face 31b) and/or when the feature is spaced apart from the second plane P2 in a direction D2 extending from the second plane P2. In arrangements where the first and second faces 31a, 31b (and associated first and second planes P1 and P2) are parallel or substantially parallel with each other, the direction D2 extends opposite the direction D1. The connector mounting structure 30 may also include another second-side wall 35 extending from the base portion 31 and positioned on the base portion second side S2 opposite the second-side wall.

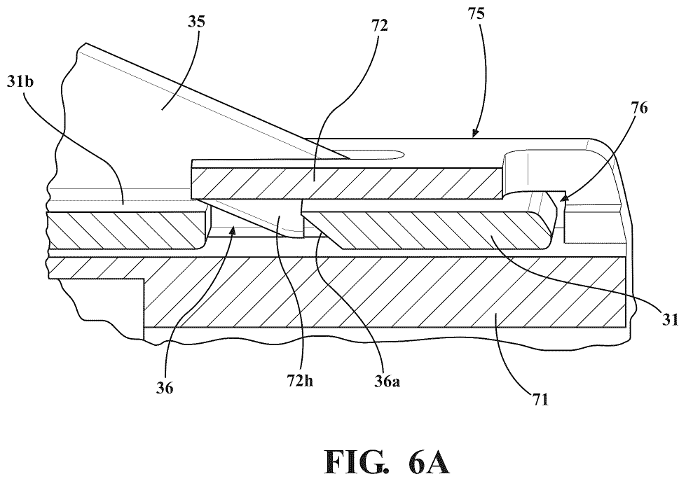

Referring to FIGS. 3 and 6A, in one or more arrangements, a latch-receiving cavity 36 may be formed in the base portion 31 between the second-side wall 34 and the other second-side wall 35. In some arrangements, latch-receiving cavity 36 may be a blind hole extending into the base portion 31 from the base portion second face 31b. In some arrangements, as shown in FIG. 6A, the latch-receiving cavity 36 may be a through-hole extending through the thickness dimension t1 of the base portion 31. The latch-receiving cavity 36 may be structured to receive therein a portion of a latch arm 72 (described below) during mating of a connector 71 of the wire harness connector assembly 70 with the connector mounting structure 30, to removably attach the connector 71 to the connector mounting structure 30.

In one or more arrangements, the connector mounting structure 30 may also include a first connecting arm 41 extending from a first edge 31e of the base portion 31 to the first-side wall 32. The first connecting arm 41 may connect the base portion 31 to the first-side wall 32, thereby providing a mutually supporting structure which increases the strength and stiffness of both the base portion 31 and the first-side wall 32.

The connector mounting structure 30 may also include a second connecting arm 42 extending from a second edge 31f of the base portion 31 opposite the first edge 31e, to the another first-side wall 33. The second connecting arm 42 may connect the base portion 31 to the another first-side wall 33, thereby providing a mutually supporting structure which increases the strength and stiffness of both the base portion 31 and the another first-side wall 33.

In one or more arrangements, the connector mounting structure 30 is formed integrally (i.e., simultaneously and contiguously with) the vehicle door touch sensor assembly body 26z using molding or any other suitable process. Alternatively, the connector mounting structure 30 may be formed separately from the touch sensor assembly body 26z and attached to the touch sensor assembly body 26z using any suitable method. In particular arrangements, the base portion 31, the first-side walls 32 and 33, the connecting arms 41 and 42 and the second-side walls 34 and 35 extend from the touch sensor assembly body interior side 26b.

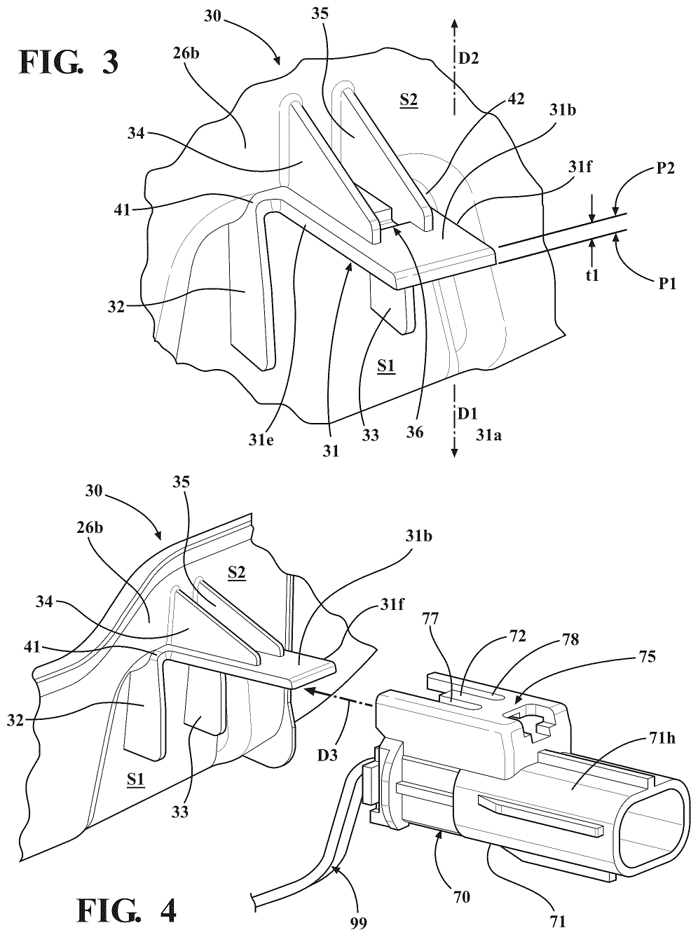

FIG. 4 is a schematic perspective view of the connector mounting structure of FIG. 3 and an exemplary wire harness connector assembly 70 including a connector 71 structured for mating engagement with the connector mounting structure 30. FIG. 4 shows the wire harness connector assembly 70 and the connector mounting structure 30 prior to mating. The connector 71 may include terminals (not shown) for terminating wires of a wire harness 99 connected to the touch sensor strip 39 through an opening in the touch sensor assembly body 26z. The connector 71 may be structured to electrically interconnect or mate with a complementary connector (not shown) of another wiring harness connected to an electronic control unit (ECU) configured for controlling operation of the vehicle door assembly 20 based on signals received from the touch sensor strip 39.

In one or more arrangements, the connector 71 may include a connector housing 73 containing the terminals. The connector 71 may also include a shroud 75 extending from the housing 73 and defining a cavity 76 (FIG. 6A) structured to receive the connector mounting structure base portion 31 therein during and after mating of the connector 71 to the connector mounting structure 30.

The shroud 75 may also include a resiliently deflectable latch arm 72 (FIGS. 6, 6A) supported in cantilever fashion by a portion of the shroud. The latch arm 72 may include a hook portion 72h structured to reside inside the base portion latch cavity 36 when the connector 71 has been mated with the connector mounting structure 30. The hook portion 72h may be structured to reside adjacent (or bear against) an edge 36a of the latch cavity 36 when the connector 71 has been mated with the connector mounting structure 30, to retain the connector 71 in the mated condition.

The shroud 75 may also include a slot formed along each side of the latch arm between the latch arm 72 and other portions of the shroud. A first slot 77 may be structured to receive therein a portion of the second-side wall 34 during mating of the connector 71 with the connector mounting structure 30. A second slot 78 may be structured to receive therein a portion of the another second-side wall 35 during mating of the connector 71 with the connector mounting structure 30. Positioning of second-side wall 34 and the another second-side wall 35 in respective first and second shroud slots 77, 78 when the connector 71 is mated to the connector mounting structure 30 may aid in further stiffening and strengthening the connection between the connector 71 and the touch sensor assembly body 26z to prevent breakage or disconnection of the connector 71 from the touch sensor assembly body 26z.

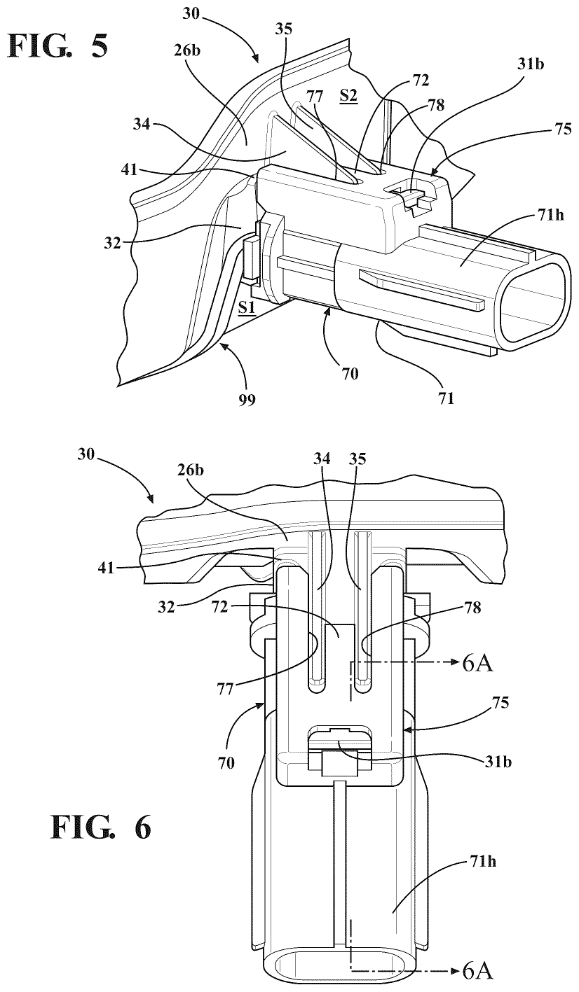

FIG. 5 is the schematic perspective view of FIG. 4 showing the connector 71 mated with the connector mounting structure 30. Referring to FIGS. 4 and 5, the connector 71 may be mated to the connector mounting structure 30 by aligning the first and second shroud slots 77, 78 with respective ones of the second-side wall 34 and the another second-side wall 35 and aligning the connector mounting structure base portion 31 with the shroud cavity 76.

Referring to FIGS. 4-6A, the connector 71 is then urged in direction D3 to mate with the connector mounting structure 30. As the connector 71 moves in direction D3, the base portion 31 is received in shroud cavity 76 while the latch arm 72 resiliently deflects and slides over the base portion second face 31b until the latch arm hook portion 72h drops into the latch cavity 36, at which point the connector 71 is mated with the connector mounting structure 30.

In one or more arrangements, the latch arm 72 and the shroud 75 may be structured so that a portion of latch arm 72 projects above the base portion second face 31b when the connector 71 is mated with the connector mounting structure 30, to enable detachment of the connector 71 from the connector mounting structure 30 by manipulating the latch arm 72 to disengage the connector 71 from the connector mounting structure 30. Also, the portion of the latch arm 72 projecting above the base portion second face 31b resides between second-side wall 34 and the another second-side wall 35.

FIG. 6 is a schematic plan view of the connector 71 mated to the connector mounting structure 30 as shown in FIG. 5. FIG. 6A is a schematic side cross-sectional view of a portion of the connector 71 and connector mounting structure 30 in the mated condition of FIGS. 4-6, showing the latch arm 72 engaged with the latch-receiving cavity 36. As seen in FIG. 6A, because part of latch arm 72 extends out of the latch-receiving cavity 76 when the connector 71 is mated with the connector mounting structure 30, the second-side wall 34 and the another second-side wall 35, in combination, operate to enclose and protect the connector latch arm 72 from damage and inadvertent actuation during handling of the touch sensor assembly body 26z. Inadvertent actuation of the latch arm 72 may result in undesired detachment of the connector 71 from the connector mounting structure 30. To disconnect the connector 71 from the connector mounting structure 30, a user may reach in between the second-side wall 34 and the another second-side wall 35 with a finger or tool to actuate the latch arm 72.

In other aspects, an electrical connector mounting structure in accordance with an embodiment described herein may be incorporated into a portion of a vehicle other than a door assembly so as to extend into an enclosure or cavity formed in the portion of the vehicle. This may enable connection of a connector and attached wire harness in other portions of a vehicle interior that are enclosed or masked, for example, by portions of the vehicle body or frame.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6A, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An electrical connector mounting structure comprising:
a base portion having a first-side and a second-side opposite the first side;
a first-side wall connected to the base portion and positioned on the base portion first side;
another first-side wall connected to the base portion and positioned on the base portion first side opposite the first-side wall;
a second-side wall extending from the base portion second side; and
another second-side wall extending from the base portion second side opposite the second-side wall.

2. The electrical connector mounting structure of claim 1, further comprising:
a first connecting arm extending from a first edge of the base portion to the first-side wall; and
a second connecting arm extending from a second edge of the base portion opposite the first edge, to the another first-side wall.

3. The electrical connector mounting structure of claim 1, further comprising a latch-receiving cavity formed in the base portion between the second-side wall and the other second-side wall.

4. The electrical connector mounting structure of claim 3, wherein the latch-receiving cavity comprises a through-hole extending through a thickness dimension of the base portion.

5. A touch sensor assembly comprising an electrical connector mounting structure including:
a base portion having a first-side and a second-side opposite the first side;
a first-side wall connected to the base portion and positioned on the base portion first side;
another first-side wall connected to the base portion and positioned on the base portion first side opposite the first-side wall;
a second-side wall extending from the base portion second side; and
another second-side wall extending from the base portion second side opposite the second-side wall.

6. The touch sensor assembly of claim 5, further comprising a body, and wherein the electrical connector mounting structure extends from an interior side of the body.

7. The touch sensor assembly of claim 5, further comprising a body, wherein the electrical connector mounting structure is formed integrally with the body.

8. A vehicle door assembly comprising an electrical connector mounting structure including:
a base portion having a first-side and a second-side opposite the first side;
a first-side wall connected to the base portion and positioned on the base portion first side;
another first-side wall connected to the base portion and positioned on the base portion first side opposite the first-side wall;
a second-side wall extending from the base portion second side; and
another second-side wall extending from the base portion second side opposite the second-side wall.

9. The vehicle door assembly of claim 8, wherein the vehicle door assembly comprises a tailgate.

10. The vehicle door assembly of claim 8, wherein the vehicle door assembly comprises a liftgate.

11. The vehicle door assembly of claim 8, further comprising a side edge and another side edge positioned opposite the side edge, wherein the electrical connector mounting structure is positioned along the side edge, and wherein the vehicle door assembly further comprises another electrical connector mounting structure in accordance with claim 8 positioned along the another side edge.

12. A vehicle including an electrical connector mounting structure in accordance with claim 1.
